(19) United States
(12) Patent Application Publication
(10) Pub. No.: US 2014/0068912 A1
(43) Pub. Date: Mar. 13, 2014

(54) Disconnect Tool

(71) Applicant: ANDREW WIRELESS SYSTEMS GMBH, Buchdorg, DE (US)

(72) Inventors: Dieter Schiele, Harburg (DE); Hermann Wiedermann, Buchdorf (DE)

(73) Assignee: ANDREW WIRELESS SYSTEMS GMBH, Buchdorf (DE)

(21) Appl. No.: 14/024,845

(22) Filed: Sep. 12, 2013

Related U.S. Application Data
(60) Provisional application No. 61/700,114, filed on Sep. 12, 2012.

(51) Int. Cl. H01R 43/26; H02G 1/00

(52) U.S. Cl. CPC H01R 43/26; H02G 1/00
USPC 29/426.6; 29/764

(57) ABSTRACT

A disconnect tool for disconnecting a cable connector from a terminal is provided. The disconnect tool can include a body and a gripping portion at a first end of the body and perpendicular to the body. The gripping portion can be adapted to engage a cable connector. The groove can have a width greater than or equal to the cable connector. Engaging the cable connector can include positioning the gripping portion such that the gripping portion partially surrounds the outer diameter of the cable connector. The width of the gripping portion can be sufficiently narrow so as to allow the gripping portion to engage a first cable connector in close proximity to a second cable connector. For a disconnect tool engaging a cable connector, applying a force to a second end of the body in an opposite direction from the cable connector can disconnect the cable connector from the terminal.

### CROSS-REFERENCE TO RELATED APPLICATIONS

Claim of priority is made to U.S. Provisional Application Ser. No. 61/700,114, filed Sep. 12, 2012 and titled “Disconnect Tool,” the contents of which are hereby incorporated by reference.

### TECHNICAL FIELD

This disclosure relates generally to electrical equipment and more particularly (although not necessarily exclusively) to tools for disconnecting cable connectors.

### BACKGROUND

Coaxial cables or other cables may be connected to terminals using cable connectors. Multiple cable connectors may be spaced closely together. It is desirable to provide a tool for disconnecting a cable connector from a terminal.

### BRIEF DESCRIPTION OF THE DRAWINGS

FIG. 1 is a perspective view of a disconnect tool according to one aspect.

FIG. 2 is a top view of the disconnect tool of FIG. 1 according to one aspect.

FIG. 3 is a longitudinal view from the top of the disconnect tool of FIG. 1 according to one aspect.

FIG. 4 is a diagram of a disconnect tool engaging a cable connector according to one aspect.

FIG. 5 is a diagram of a force being applied to the disconnect tool of FIG. 4 according to one aspect.

FIG. 6 is a diagram of an additional force being applied to the disconnect tool of FIGS. 4-5 according to one aspect.

FIG. 7 is a diagram of a disconnect tool in a storage mechanism according to one aspect.

FIG. 8 is a diagram of a force being applied to a disconnect tool for disengaging the disconnect tool from the storage mechanism of FIG. 7 according to one aspect.

FIG. 9 is a diagram of an additional force being applied to a disconnect tool for disengaging the disconnect tool from the storage mechanism of FIG. 7 according to one aspect.

FIG. 10 is a diagram of an additional force being applied to a disconnect tool for removing the disconnect tool from the storage mechanism of FIG. 7 according to one aspect.

FIG. 11 is a diagram of the disconnect tool being removed from the storage mechanism of FIG. 7 according to one aspect.

### DETAILED DESCRIPTION

Certain aspects and embodiments are directed to a disconnect tool for disconnecting a cable connector from a terminal. The disconnect tool can include a body and a gripping portion at a first end of the body and perpendicular to the body. The gripping portion can be adapted to engage a cable connector. For example, the gripping portion can include a rounded portion defining a groove. The groove can have a width greater than or equal to the cable connector. Engaging the cable connector can include positioning the gripping portion such that the gripping portion partially surrounds the outer diameter of the cable connector. The width of the gripping portion can be sufficiently narrow so as to allow the gripping portion to engage a first cable connector in close proximity to a second cable connector. For example, the gripping portion may have a width greater than a diameter or width of the first cable connector and less than a combined width of the first and second cable connectors. For a disconnect tool engaging a cable connector, applying a force to a second end of the body in an opposite direction from the cable connector can disconnect the cable connector from the terminal.

Detailed descriptions of certain aspects are discussed below. These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative aspects but, like the illustrative aspects, should not be used to limit the present invention.

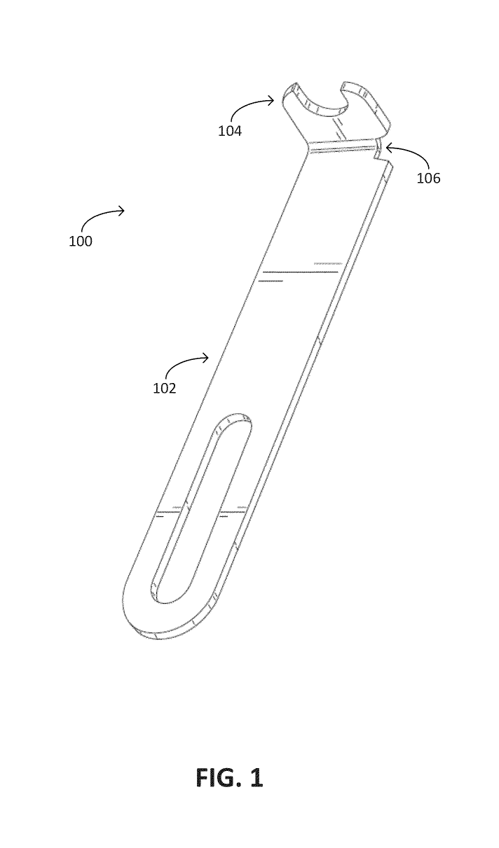

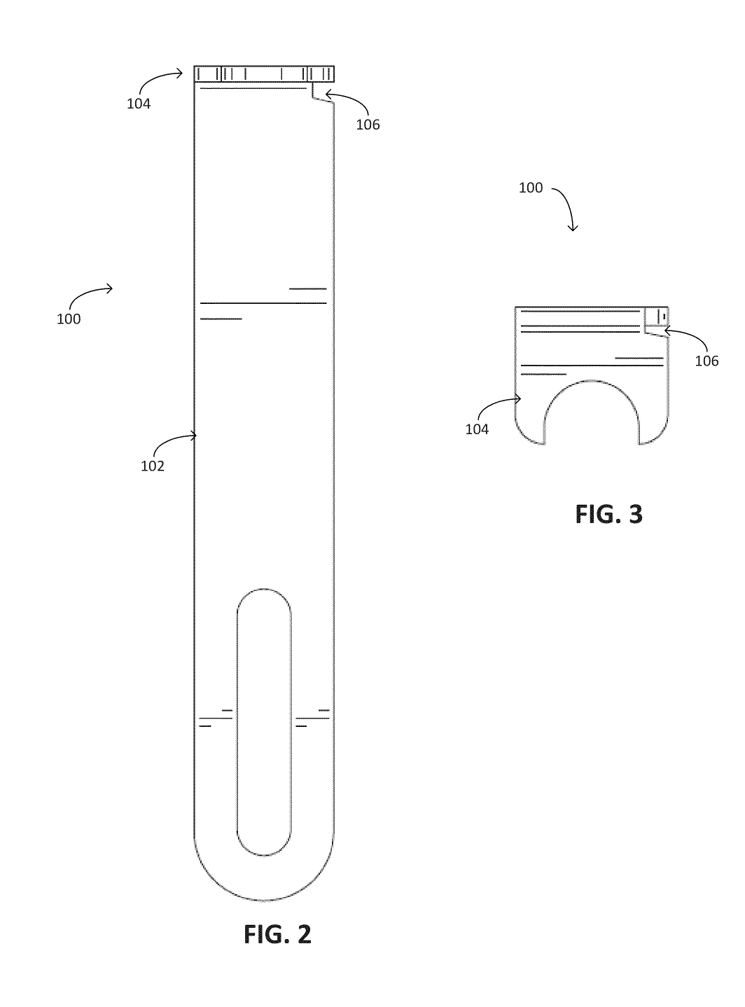

FIG. 1 is a perspective view of an example of a disconnect tool 100. The body 102 can be formed from any suitable rigid material. Non-limiting examples of suitable rigid material can include metal, ceramic, plastic, and the like. In some aspects, the body 102 can be integral with the gripping portion 104. In other aspects, the body 102 can be a separate piece coupled to the gripping portion 104. The disconnect tool 100 can include a retention portion 106 defining a notch or groove. FIG. 2 is a top view of the disconnect tool 100. FIG. 3 is a longitudinal view from the top of the disconnect tool 100. In some aspects, the retention portion 106 can be adjacent to the gripping portion 104, as depicted in FIGS. 2-3. In other aspects, the retention portion 106 can be formed at other positions in the body 102.

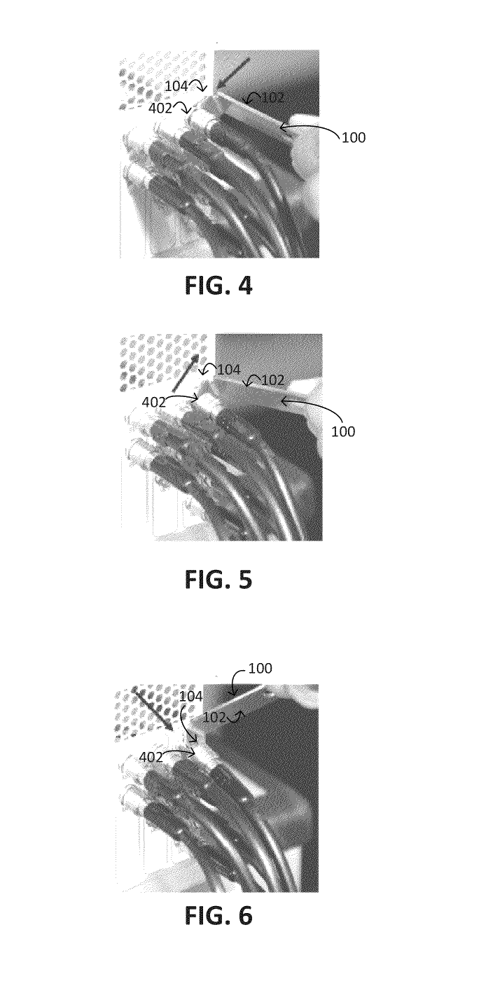

A non-limiting example of the operation of a disconnect tool 100 is provided in FIGS. 4-6. A non-limiting example of a cable connector usable with the disconnect tool 100 is a push-pull connector 402, such as (but not limited to) a QMA RF connector, a QN RF connector, and the like. The gripping portion 104 can be positioned to engage the push-pull connector 402, as depicted in FIG. 4 by the arrow pointing down and to the left. A push-pull connector 402 can include a cylindrical body having an outer sleeve. The outer sleeve can secure the connector 402 to a terminal. The outer sleeve can be spring-loaded. Applying a lateral force (e.g., a “push”) to the outer sleeve can cause the spring to compress. The force can be applied to a push-pull connector by engaging the gripping portion 104 with the push-pull connector (as depicted in FIG. 4) and applying an additional force to the body 102 in an opposite direction from the push-pull connector 402, as depicted in FIG. 5 by the arrow pointing up and to the right. The additional force can cause the first force to be applied to the outer sleeve by the gripping portion 104. Applying a second lateral force to the cylindrical body (e.g., a “pull”) can disengage the push-pull connector 402, as depicted in FIG. 6 by the arrow pointing down and to the right. The second force can be applied by continuing to apply force to the body 102 in an opposite direction from the push-pull connector 402.

Non-limiting example widths or diameters of cable connectors can include 5 millimeters, a diameter of 10 millimeters for QMA connectors, or a range of 12-14 millimeters. Multiple cable connectors can be connected to terminals of a piece of equipment, such as a sub-rack, at close intervals. Non-limiting example intervals between terminals include 15-17 millimeters and 50 millimeters. In another non-limiting example, cable connectors such as QMA connectors can be positioned in a grid wherein the cable connectors are spaced at intervals of 31 millimeters or less.

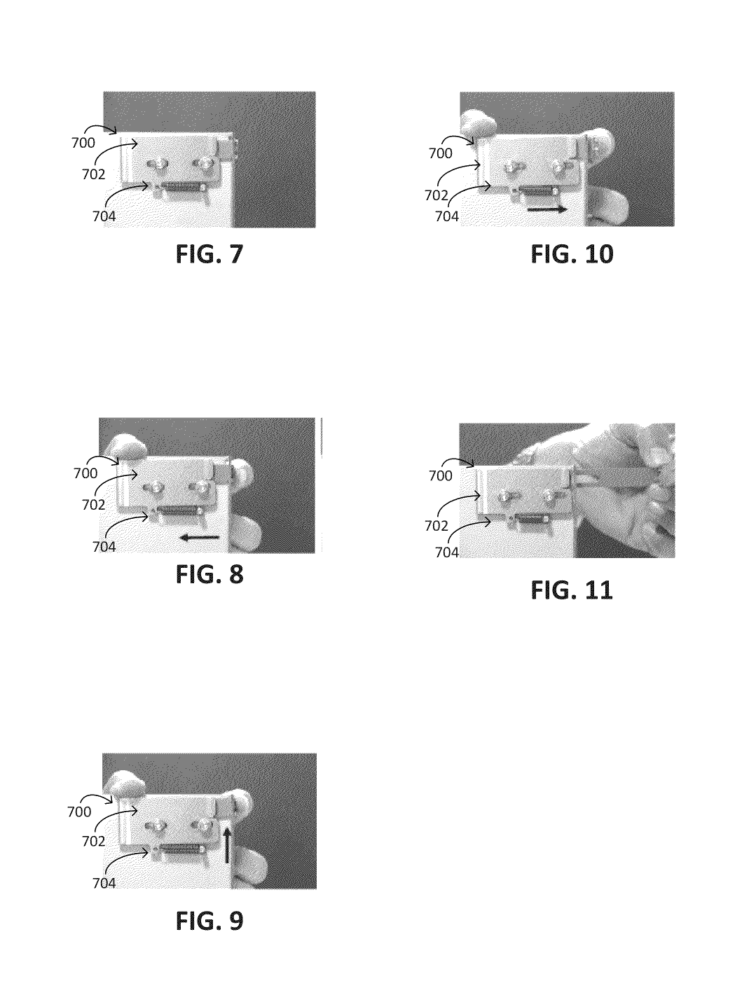

In additional or alternative aspects, a disconnect tool 100 can be adapted for storage in a storage mechanism located at or near a piece of equipment having terminals, as depicted in FIGS. 7-12. An example of a storage mechanism 700 depicted in FIG. 7 is a sleeve 702 having a spring-loaded displacement mechanism 704. An example of a spring-loaded displacement mechanism 704 is a rigid piece within the sleeve 702 adjacent to an expansion spring. A disconnect tool 100 can be placed within the sleeve 702, thereby applying a force to the rigid piece and causing the expansion spring to compress. The retention portion 106 of the disconnect tool 100 can engage a retention portion 106 of the sleeve 702, such as a tooth. Engaging the retention portion 106 of the disconnect tool 100 with the retention portion 106 of the sleeve 702 can prevent the expansion spring of the storage mechanism 700 from expanding, thereby securing the disconnect tool 100 in the storage mechanism 700. The retention portion 106 of the disconnect tool 100 can be positioned in the body 102 of the disconnect tool 100. The disconnect tool 100 can be removed from the storage mechanism 700 by applying a force to the disconnect tool 100 compressing the spring, as depicted by the leftward arrow in FIG. 8, and a force causing the retention portion 106 of the disconnect tool 100 to disengage from the retention portion 106 of the sleeve 702, and the upward arrow in FIG. 9. Disengaging the retention portion 106 of the disconnect tool 100 from the retention portion 106 of the sleeve 702 can allow the expansion spring to expand, thereby displacing the disconnect tool 100 from the storage mechanism 700, as depicted by the rightward arrow in FIG. 10. The disconnect tool 100 can be removed from the storage mechanism 700, as depicted in FIG. 11.

The foregoing description of the examples, including illustrated examples, of the invention has been presented only for the purpose of illustration and description and is not intended to be exhaustive or to limit the invention to the precise forms disclosed. Numerous modifications, adaptations, and uses thereof will be apparent to those skilled in the art without departing from the scope of this invention. The illustrative examples described above are given to introduce the reader to the general subject matter discussed here and are not intended to limit the scope of the disclosed concepts.

What is claimed is:

1. A disconnect tool comprising:
a body; and
a gripping portion at a first end of the body, the gripping portion perpendicular to the body, wherein the gripping portion is adapted to:
engage a cable connector having a cable coupled to the connector,
apply a lateral force to the cable connector in response to a force being applied to a second end of the body, and
disconnect the cable connector while the cable is coupled to the cable connector;
wherein the gripping portion has a width greater than a width of the cable connector and less than double the width of the cable connector.

2. A method comprising:
engaging, by a gripping portion at a first end of a body of a disconnect tool, a cable connector having a cable coupled to the connector;
applying a force to a second end of the body in a direction opposite the cable connector, the force causing a lateral force to be applied to the cable connector, and
disconnecting the cable connector while the cable is coupled to the cable connector.
